(19) United States
(12) Patent Application Publication
(10) Pub. No.: US 2008/0048467 A1
(43) Pub. Date: Feb. 28, 2008

(54) Storage compartment

(75) Inventor: Thomas Vorberg, Goldbach (DE)

Correspondence Address: COHEN, PONTANI, LIEBERMAN & PAVANE, 551 FIFTH AVENUE, SUITE 1210, NEW YORK, NY, 10176, US

(73) Assignee: Siemens VDO Automotive AG

(21) Appl. No.: 11/880,695

(22) Filed: Jul. 24, 2007

(30) Foreign Application Priority Data
Jul. 24, 2006 (DE) 10 2006 034 182.1

(51) Int. Cl. B60R 7/04

(52) U.S. Cl. 296/37.8

(57) ABSTRACT

A storage compartment in a vehicle interior is accessible via an opening and includes a hook to make it possible to hang up different objects without disturbing the interior when the hanging device is not in use. The hook is moveable from a rest position into an accessible use position and is arranged in the region of the opening. In the folded-down rest position, the hook rests on the bottom of the storage compartment and can be pivoted into the use position.

### BACKGROUND OF THE INVENTION

1. Field of the Invention

The present invention relates to a storage compartment in a vehicle interior which is accessible via an opening.

2. Description of the Related Art

Storage compartments are used in motor vehicles in order to stow and to store objects. The objects may comprise objects which are relevant to the operation of the vehicle such as, for example, operating instructions, a service manual, road maps or an ice scraper. However, storage compartments are also used for storing personal objects of the vehicle users such as, for example, cassettes, CDs, writing tools, mobile telephones, lipsticks. Storage compartments are provided in different sizes, at different points, open or closed, lockable, for the different purposes. The range extends from the simple open storage compartment to a cooled glove compartment. However, it has been shown that, in conjunction with the increased requirements for additional fittings in the region of the interior of a vehicle, a need exists also to be able to hang different objects on hooks. Hooks for hanging, for example, jackets and coats on are known in diverse forms in the region of the grab handles arranged above the doors. In addition, fixed hooks in the region of the front passenger module are known. However, with projecting hooks, from the aspect of safety there is a great risk of injury to the user in the event of an impact. A further disadvantage of the known solutions is that the hooks are designed to be installed fixedly and are therefore visible even when they are not being used. This signifies a great limitation with regard to the design of the interior of the vehicle. Hooks are therefore often not provided at all, since they cannot be integrated into the construction space for design reasons.

### SUMMARY OF THE INVENTION

An object of the present invention is therefore to provide a hanging device on which different objects may be hung without interfering with an automotive interior when the hanging device is not in use.

According to an embodiment of the invention, the object is achieved by a storage compartment in a vehicle interior in which a hook for hanging objects is provided, the hook being moveable from a rest position into an accessible use position and being arranged in the region of an opening of the storage compartment.

An advantage of the storage compartment according to the present invention is that the hook provides an option for hanging up objects, but it is only visible when the hook is being used. When not in use, the hook is moved from a use position into a rest position. When the hook is in the rest position, it merges visually into the background and the compartment can be used in the conventional manner as a storage facility.

The storage compartment is preferably arranged in the cockpit in the region of the center console or in the region of the front passenger. Of course, however, the storage compartment may also be arranged at another location in the vehicle such as, for example, in the rear of the vehicle.

In a preferred embodiment, the hook is pivotable from a folded-down rest position into the use position. This movement can be realized by a simple mechanism in the manner of a hinge. This embodiment additionally permits simple operation by the user. Other types of movement are also suitable as the movement mechanism of the hook. For example, the storage compartment may alternatively be provided with a hook that is moved to the use position by pulling out, swinging upward or pushing down. Combinations of these movements are also suitable for the movement of the hook.

The hook expediently has a latching mechanism and is latched in place in the use position. In this case, the hook is not inadvertently moved back into its rest position while an object such as, for example, a small bag is hanging on it.

According to a further embodiment, the hook at least partially closes the opening of the storage compartment in the use position. As a result, objects such as, for example, a mobile telephone, are prevented from dropping out of or otherwise being ejected from the storage compartment.

According to yet another embodiment, the hook is fastened pivotably to the lower edge of the opening. As a result, the hook can be moved from the use position into the rest position by it being simply folded into the compartment.

In a further embodiment, the hook rests on the bottom of the storage compartment in the rest position. This results in a simple and cost-effective configuration of the storage compartment.

The hook may be located in a recess of the bottom surface when it is in the rest position. The recess may further have a recessed grip for the unfolding of the hook. By the hook being arranged in a recessed manner in the rest position, a planar bottom of the storage compartment arises when the hook is not in use, the planar surface merely having the recessed grip allowing the hook to be unfolded.

In order to achieve a hook which has as great a load-bearing capacity as possible, the hook is fastened to a concealed structural part according to yet a further embodiment. Since the loads are not introduced into the housing of the storage compartment, the latter can be designed in a correspondingly simple manner, since the weights which are absorbed by the hook are introduced directly into a stable, not directly visible structural part, and therefore the hook can absorb relatively large weights.

In a practical embodiment, a predetermined breaking point is provided on the hook and prevents the structural part and therefore possibly also the storage compartment itself from being damaged if too great a load is introduced. If too great a load is introduced, the hook breaks at the designated point without damaging the fastening point. After removal of a panel, the hook can simply be exchanged without having to remove the storage compartment itself. The predetermined breaking point is preferably arranged in such a manner that the storage compartment can still be safely used even if a hook has broken off.

In still a further embodiment, the hook does not protrude out of the storage compartment in the use position. This reduces the risk of injury to the vehicle occupants and also ensures that the hook is not greatly emphasized and does not interfere with the design of the interior.

In a particularly practical embodiment, an opening for wedging cloths and/or bags in is provided in the hook. This measure allows the vehicle user to fasten, for example, a wiping cloth or towel, in a simple manner, with it being immediately accessible at all times.

The last-mentioned embodiment can be supplemented further by the opening on the lower edge in the use position being provided with a downwardly extending gap which tapers toward the end, for allowing even relatively small cloths or other flexible materials to be wedged therein. For a particularly good support, the edges of the gap and/or of the opening are provided with a rubber coating.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a front view of a hook integrated in a storage compartment according to an embodiment of the present invention;

FIG. 2 is a schematic sectional view in order to clarify the rotational movement of the hook according to FIG. 1;

FIG. 3 shows a further embodiment of the arrangement of the hook in the rest position;

FIG. 4 shows a hook according to FIG. 1 with an additional wedging opening, and FIG. 5 shows a section through a storage compartment with a hook according to another embodiment of the present invention.

### DETAILED DESCRIPTION OF THE PRESENTLY PREFERRED EMBODIMENTS

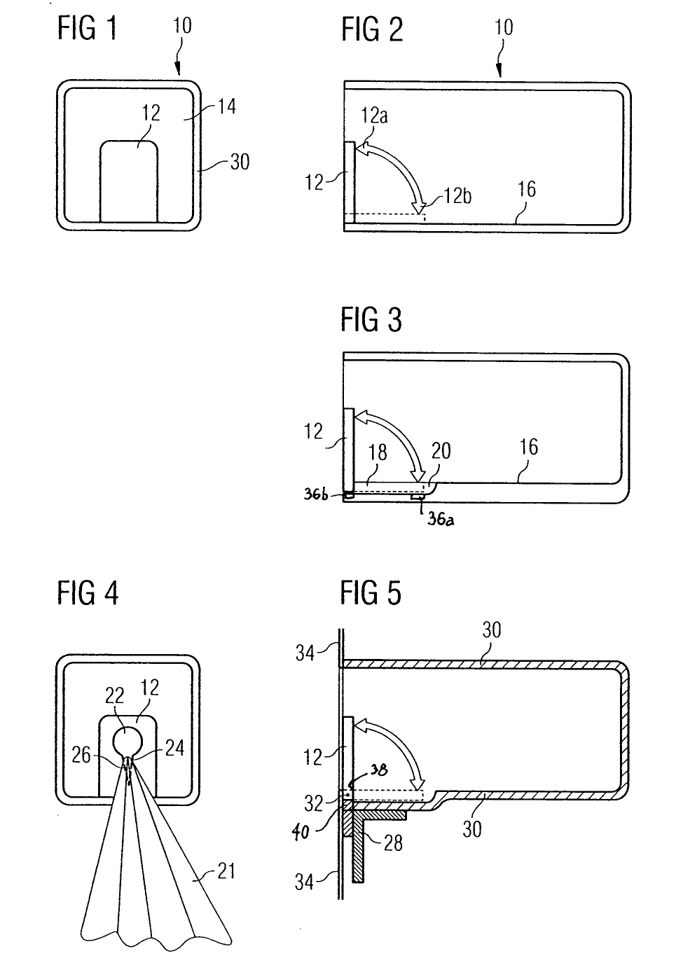

FIG. 1 shows a storage compartment 10 in a vehicle interior, in which a hook 12 is provided. The storage compartment 10 is accessible through an opening 14. The hook 12 is arranged in the region of the opening 14 of the storage compartment, on the lower edge of the opening 14. In FIG. 1, the hook 12 is in a use position 12a. FIG. 2 schematically illustrates the rotational movement of the hook 12, with the hook 12 being pivotable from the use position 12a into a folded-down rest position 12b. In a further embodiment shown in FIG. 2, in the rest position 12b the hook 12 rests on the bottom 16 of the storage compartment 10. In an alternative embodiment to this, the hook 12 is located in a recess 18 of the bottom surface 16 in the rest position 12b, as illustrated in FIG. 3. In order to unfold the hook 12, a recessed grip 20 is provided in the recess 18.

In order to improve the user's comfort, other mechanisms for unfolding the hook 12 instead of the recessed grip 20 may alternatively be used. For example, a type of latching mechanism 36a known per se, in which, in the rest position 12b, the hook is first of all pressed by the user in the direction of the bottom surface 16, as a result of which the latching mechanism 36a releases the hook 12 and the hook 12 is folded by a spring mechanism 36b into the use position 12a.

FIG. 4 shows a hook 12 with an additional wedging opening 22 for the hanging up of, for example, cloths 21 or bags. On the lower edge in the use position 12a, the wedging opening 22 has a downwardly extending gap 24 which tapers toward the end. Relatively thin materials or bags may also be wedged in said gap 24. In order to ensure as good a support as possible, the edges 26 of the gap 24 and/or of the opening 22 are provided with a rubber coating.

As is apparent from FIG. 5, the hook 12 is fastened to a concealed structural part 28. The loads introduced into the hook 12 are dissipated by the structural part 28. This feature allows the walls 30 of the storage compartment 10 to be of correspondingly thin dimensions, since they are not subjected to the loads of the hook 12. A predetermined breaking point 38 is provided on the hook 12 and ensures that, if the hook 12 is overloaded, deformation of the structural part 28 or even damage to the housing walls 30 of the storage compartment 10 does not occur. In order to be able to safely use the storage compartment 10 even if a hook 12 has broken off, the predetermined breaking point 38 is arranged as close as possible to a joint 32 of the hook 12.

The front edge of the storage compartment 10 is provided with an encircling panel 34 which also conceals the fastening of the hook 12 to the supporting structural part 28. In the event of a repair, for example if a hook 12 is defective, the panel 34 merely has to be removed in order to be able to exchange the hook 12. The storage compartment 10 does not need to be disassembled for this.

The movement mechanism of the hook 12 may have a latching mechanism 40, and therefore the hook can latch in place in the use position 12a. This prevents the hook 12 from being inadvertently pivoted back into the rest position 12b when an object is hanging on it.

In the use position 12a, the hook 12 does not protrude out of the surface which surrounds the storage compartment 10 and faces the vehicle occupant. This reduces the risk of injury to a minimum. In addition, it is therefore ensured that the hook 12 does not unnecessarily interfere with the cockpit design.

The hook 12 is dimensioned in such a manner that, in the use position 12a, it at least partially closes the opening 14 of the storage compartment 10. This locking of the storage compartment 10 makes it possible to prevent objects, e.g., a mobile phone, from dropping out. The distance between hook 12 and the walls 30 of the storage compartment 10 is dimensioned to be of a size sufficient that the user can easily move the hook 12 from the nonusable rest position 12b into the use position 12a, and vice versa, i.e., so much space is provided around the hook 12 that pinching of fingers is ruled out.

The storage compartment 10 with the foldable hook 12 can be easily integrated into various design concepts, since the hook 12 only appears in the use position 12a. By means of the possibility of securely fastening objects, such as, for example, paper bags or bags, in the vehicle by means of the hook 12, the storage compartment 10 with the hook 12 also makes a contribution to increasing the general road safety, since bags or paper bags can be kept from unintentionally emptying out. At the same time, the device meets the requirements in the region of the interior of vehicles, in which, especially in the cockpit region, as great a freedom of design as possible is to be maintained.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A storage compartment in a vehicle interior, said storage compartment defining an opening through which an interior of said storage compartment is accessible, said storage compartment comprising a hook for hanging objects on, said hook being movably mounted in said storage compartment so that said hook is moveable from a rest position into an accessible use position and being arranged in a region of the opening.

2. The storage compartment of claim 1, wherein said hook is pivotable from the rest position into the use position.

3. The storage compartment of claim 1, wherein said hook has a latching mechanism configured to latch said hook in place in the use position.

4. The storage compartment of claim 1, wherein said hook at least partially closes the opening of said storage compartment when said hook is in the use position.

5. The storage compartment of claim 1, wherein said hook is fastened pivotably at a lower edge of the opening.

6. The storage compartment of claim 5, wherein said hook rests on a bottom of said storage compartment when said hook is in the rest position.

7. The storage compartment of claim 5, wherein said storage compartment defines a recess in the bottom surface, said hook being located in the recess of the bottom surface when said hook is in the rest position, the recess further defining a recessed grip for facilitating the unfolding of said hook from the rest position.

8. The storage compartment of claim 1, further comprising a concealed structural part, said hook being connected to said concealed structural part so that said concealed structural part supports a load on said hook.

9. The storage compartment of claim 8, wherein a predetermined breaking point is provided on said hook.

10. The storage compartment of claim 1, wherein said hook does not protrude from the storage compartment when said hook is in the use position.

11. The storage compartment of claim 1, wherein said hook defines an opening for wedging cloths or bags.

12. The storage compartment of claim 11, wherein a lower edge of the opening with respect to the use position has a downwardly extending gap which tapers toward the end.

13. The storage compartment of claim 12, further comprising a rubber coating on edges of at least one of the gap or the opening.
